(19) United States
(12) Patent Application Publication
(10) Pub. No.: US 2022/0389196 A1
(43) Pub. Date: Dec. 8, 2022

(54) RESIN COMPOSITION AND PRODUCTION METHOD OF SAME

(71) Applicant: Konica Minolta, Inc., Tokyo (JP)

(72) Inventors: Takeshi KOJIMA, Tokyo (JP); Masashi MAMINO, Tokyo (JP); Yuuki NAGAI, Tokyo (JP); Yo NAKAJIMA, Tokyo (JP)

(21) Appl. No.: 17/825,140

(22) Filed: May 26, 2022

(30) Foreign Application Priority Data
Jun. 8, 2021 (JP) 2021-095797

(51) Int. Cl. C08K 13/04

(52) U.S. Cl. CPC C08K 13/04

(57) ABSTRACT

Provided is a resin composition for injection molding including a polyolefin resin, containing: at least one selected from the group consisting of aluminum hydroxide, magnesium hydroxide and a phosphorus compound in an amount of 10 to 60 mass %; a NOR-type hindered amine compound in an amount of 0.05 to 5 mass %; and a fibrous filler having an aspect ratio of 10 or more in an amount of 1 to 20 mass %, respectively, relative to the total amount of the resin composition, wherein a phosphorous content is 5 mass % or less relative to the total amount of the resin composition.

### CROSS-REFERENCE TO RELATED APPLICATIONS

The entire disclosure of Japanese Patent Application No. 2021-095797 filed on Jun. 8, 2021 is incorporated herein by reference in its entirety.

### BACKGROUND

### Technological Field

The present invention relates to a resin composition and a method for producing the same. More particularly, the present invention relates to a resin composition for injection molding and a production method thereof, which may economically produce an injection molded product with excellent mechanical strength, flame retardancy and appearance with stable quality.

### Description of the Related Art

Polyolefin resins such as polypropylene are used in various applications because of their light weight, excellent chemical resistance, high elongation, and low cost. Since polyolefin resins are highly flammable, when flame retardancy is required for molded products, resin compositions added with large amounts of flame retardants to the resin are used. However, the addition of a flame retardant may impair the above characteristics of polyolefin resins. As the flame retardant, various flame retardants such as halogen compounds, phosphorus compounds, and metal hydrates are conventionally known. It is also known to add fillers such as a glass fiber to polyolefin resins to improve the strength of the molded product.

As a technology to improve both flame retardancy and strength, Patent Document 1 (JP-A 10-338774) describes the following. A flame retardant containing ammonium polyphosphate and a nitrogen compound and a long glass fiber are added to a polyolefin resin. The description was made to a long glass fiber-containing resin composition which is excellent in balance characteristics of rigidity and impact resistance, has good flame retardancy, elongation characteristics, and dimensional stability, and enables to obtain an effect of preventing drip during combustion.

Further, Patent Document 2 (JP-A 2011-088970) describes the following method. A pellet made by impregnating a long fiber glass having a length of 2 to 50 mm with a polyolefin resin and a pellet made of a composition of the polyolefin resin and a specific phosphate are dry-blended, and the mixture is made into a flame-retardant resin composition containing long glass fiber. This is a method for obtaining a molded product by a method of directly molding as a resin composition. Patent Document 2 describes that when a long fiber glass pellet impregnated with a polyolefin resin having a length of 2 to 50 mm is used, the average length of the glass fiber in the molded product is 1 to 6 mm. It is stated that glass fibers of this length improve the oxygen index.

However, in these technologies, polyolefin resin compositions contain fillers such as glass fibers with relatively high hardness, which may cause wear to the molds in injection molding. This problem was especially noticeable at the gate of the mold, where the resin composition flows at high shear rate and high pressure. In addition, flame retardants that generate acidic gases, such as those using a phosphorus compound, accelerate mold wear due to corrosion, and flame retardants such as metal hydroxides accelerate mold wear due to the increased amount of hard fillers. The mold wear is problematic because it results in a lower yield of molded products and increased production costs due to mold changes.

Hindered amine light stabilizers are also used in various fields as light-stabilizing agents to prevent degradation to light, and NOR-type hindered amine compounds (sometimes indicated as “NOR-type HALS”) are known to act as a flame retardant and may efficiently enhance flame retardancy (see, for example, Patent Documents 3 and 4).
Patent Document 3: JP-A 2002-507238
Patent Document 4: JP-A 2015-189785

In these Patent Documents, it is shown that flame retardancy and weather resistance are improved for films, sheets, or fibers, but no mention is made of other effects, such as the inhibition of wear and corrosion of molds in injection molding.

### SUMMARY

The present invention was made in view of the above problems and circumstances, and its solution is to provide a resin composition for injection molding and a production method thereof, which may economically produce an injection molded product with excellent mechanical strength, flame retardancy and appearance with stable quality.

In order to solve the above problem, in the process of examining the cause of the above problem, the present inventor has developed a resin composition for injection molding containing polyolefin resin. This resin composition contains at least one selected from the group consisting of aluminum hydroxide, magnesium hydroxide, and a phosphorus compound, at least one of the following NOR-type hindered amine compounds, and fibrous filler having an aspect ratio of 10 or more each contained in specific proportions, and a phosphorus content in the resin composition is made to be a specific amount or less. Thereby it is possible to provide a resin composition for injection molding that may economically produce an injection molded product with excellent mechanical strength, flame retardancy, and appearance with stable quality. Thus, the present invention has been achieved. In other words, the above issues related to the present invention are solved by the following means.

To achieve at least one of the above-mentioned objects of the present invention, a resin composition for injection molding containing a polyolefin resin that reflects an aspect of the present invention is as follows.

A resin composition for injection molding comprising a polyolefin resin, containing:

at least one selected from the group consisting of aluminum hydroxide, magnesium hydroxide and a phosphorus compound in an amount of 10 to 60 mass %;

a NOR-type hindered amine compound in an amount of 0.05 to 5 mass %; and

a fibrous filler having an aspect ratio of 10 or more in an amount of 1 to 20 mass %, respectively, relative to the total amount of the resin composition,

wherein a phosphorous content is 5 mass % or less relative to the total amount of the resin composition.

The above means of the present invention may provide a resin composition for injection molding and production methods thereof that may economically produce an injection molded product with excellent mechanical strength, flame retardancy, and appearance with stable quality. The expression mechanism or action mechanism of the effect of the invention is inferred as follows.

The present inventor considered it is necessary to include a specific amount of fibrous filler having an aspect ratio of 10 or more in a resin composition containing a polyolefin resin to obtain mechanical strength in the injection molded product. However, when the fibrous filler having an aspect ratio of 10 or more passes through the mold gate at high speed and high pressure in injection molding, mold wear will occur. In the present invention, by blending a specific amount of NOR-type HALS, the melt viscosity of the resin composition at this time is lowered and the mold wear is suppressed.

It is generally known that the NOR-type HALS has a radical trap effect (see, e.g., Patent Document 3). In addition, the NOR-type HALS has a drip promoting effect, as shown in JP-A 2004-263033. It is presumed that the drip promoting effect of the NOR-type HALS reflects the phenomenon that the melt viscosity sharply decreases when the temperature rises sharply due to combustion.

Since shear heating also occurs at the gate where the resin composition flows at high pressure and high speed during injection molding of the resin composition containing the above fibrous filler, the NOR-type HALS is assumed to act to reduce the melt viscosity at this time. Thus, by blending a specific amount of NOR-type HALS in a resin composition containing the above-mentioned fibrous filler, we believe that this has helped to suppress mold wear.

In the resin composition of the present invention, at least one selected from the group consisting of aluminum hydroxide, magnesium hydroxide and a phosphorus compound is further contained as a flame retardant in a specific amount, provided that a phosphorous content is 5 mass % or less, so that the above molded product is flame retardant while maintaining its effectiveness in reducing wear. Here, the NOR-type HALS also functions as a flame retardant, but in the present invention, the flame retardancy of the molded product is sufficiently ensured by the combination with at least one selected from the group consisting of aluminum hydroxide, magnesium hydroxide and a phosphorus compound.

Although there are concerns that aluminum hydroxide, magnesium hydroxide, and a phosphorus compound may accelerate mold wear as described above, the combination of the NOR-type HALS made it possible to reduce its content. When the resin composition of the present invention is used for injection molding, the load on the equipment during injection molding, such as wear of the mold, is reduced, thereby improving the yield of the molded product and controlling production costs for replacement of mold and other parts.

Thus, in the resin compositions of the present invention, the above configuration enables economical production of the injection molded product with excellent mechanical strength, flame retardancy, and appearance with stable quality.

### DETAILED DESCRIPTION OF THE EMBODIMENTS

Hereinafter, one or more embodiments of the present invention will be described. However, the scope of the invention is not limited to the disclosed embodiments.

The resin composition of the present invention is a resin composition for injection molding comprising a polyolefin resin, and contains at least one selected from the group consisting of aluminum hydroxide, magnesium hydroxide and a phosphorus compound in an amount of 10 to 60 mass %, a NOR-type hindered amine compound in an amount of 0.05 to 5 mass %, and a fibrous filler having an aspect ratio of 10 or more in an amount of 1 to 20 mass % relative to the total amount of the resin composition, respectively, and wherein a phosphorous content is 5 mass % or less relative to the total amount of said resin composition. This feature is a technical feature common to each of the following embodiments.

As an embodiment of the resin composition of the present invention, it is preferable that the polyolefin resin is a polypropylene resin because the effect of the present invention is more remarkably exhibited.

As an embodiment of the resin composition of the present invention, from the viewpoint of exhibiting the effect of the present invention, it is preferable that the phosphorus compound contains a phosphate ester compound.

In an embodiment of the resin composition of the present invention, from the viewpoint of exhibiting the effect of the present invention, it is preferable that a mass ratio of the total content of the aluminum hydroxide and the magnesium hydroxide to the content of the phosphorus compound is in the range of 100:0 to 75:25.

As an embodiment of the resin composition of the present invention, it is preferable that an aspect ratio of the fibrous filler is 50 or more from the viewpoint of exhibiting the effect of the present invention.

As an embodiment of the resin composition of the present invention, it is preferable that the fibrous filler contains halloysite from the viewpoint of exhibiting the effect of the present invention.

The method for producing a resin composition of the present invention is a method comprising: a first step of melt kneading the polyolefin resin, at least one selected from the group consisting of aluminum hydroxide, magnesium hydroxide and a phosphorus compound, and the NOR-type hindered amine compound to obtain a resin mixture; and a second step of melt kneading the resin mixture and a raw material component of the fibrous filler having an aspect ratio of 10 or more.

Even when a material whose aspect ratio is likely to change due to cutting is used as a raw material component of the fibrous filler having an aspect ratio of 10 or more by the above producing method, the aspect ratio of 10 or more may be achieved in the obtained resin composition.

Hereinafter, the present invention, its constituent elements, and modes and embodiments for carrying out the present invention will be described in detail. In this application, “to” is used in the sense of including the numerical values described before and after “to” as a lower and an upper limit, respectively.

### [Resin Composition]

The resin composition of the present invention is a resin composition for injection molding comprising a polyolefin resin, and at least one selected from the group consisting of aluminum hydroxide, magnesium hydroxide and a phosphorus compound (hereinafter, also referred to as component (A)) is contained in an amount of 10 to 60 mass % based on the total amount of the resin composition, and a NOR-type hindered amine compound (hereinafter, also referred to as a component (B)) is contained in an amount of 0.05 to 5 mass %, and a fibrous filler having an aspect ratio of 10 or more (hereinafter, also referred to as component (C)) is contained in an amount of 1 to 20 mass %. Moreover, a phosphorus content is in an amount of 5 mass % or less with respect to the total amount of the resin composition.

In addition to the above components, the resin composition of the present invention may optionally contain other resins than the polyolefin resin and various additives generally contained in a resin composition to the extent that the effect of the present invention is not impaired. The following is an explanation of each component in the resin composition of the present invention.

### (Polyolefin Resin)

A polyolefin resin is a homopolymer or copolymer polymerized with an olefin as the main monomer component. In this specification, an “olefin” refers to an aliphatic chain unsaturated hydrocarbon having one double bond.

Here, the main component constituting the resin (polymer) means a component having an amount of 50 mass % or more in all the monomer components constituting the polymer. The polyolefin resin is a homopolymer or a copolymer containing olefin in all monomer components, preferably in an amount of 60 to 100 mass %, more preferably 70 to 100 mass %, still more preferably 80 to 100 mass %.

The olefin copolymers include copolymers of olefins with other olefins or copolymers of olefins with other monomers copolymerizable to olefins. The content of the above other monomer in the polyolefin resin is preferably less than 30 mass %, and more preferably 0 to 20 mass % in the total monomer component.

Preferred olefins are α-olefins having 2 to 12 carbon atoms. Examples of the olefin include ethylene, propylene, 1-butene, isobutene, 1-pentene, 3-methyl-1-hexene, 1-octene, 1-octene, and 1-decene. In the polymerization of the polyolefin resin, one olefin may be used alone or in combination with two or more olefins.

Examples of the other monomer that may copolymerize with the olefin include cyclic olefins such as cyclopentene and norbornene, and dienes such as 1,4-hexadiene and 5-ethylidene-2-norbornene. Further, monomers such as vinyl acetate, styrene, (meth)acrylic acid and its derivatives, vinyl ether, maleic anhydride, carbon monoxide, and N-vinylcarbazole may be used. One of the above other monomers may be used alone or in combination with two or more monomers in the polymerization of polyolefin resin. The term “(meth)acrylic acid” means at least one of acrylic acid or methacrylic acid.

Examples of the polyolefin resin include polyethylene resins mainly composed of ethylene such as high density polyethylene (HDPE), low density polyethylene (LDPE), and linear low density polyethylene (LLDPE); polypropylene resins mainly composed of propylene such as polypropylene (propylene homopolymer), ethylene-propylene copolymer, propylene-butene copolymer, ethylene-propylene-butene copolymer, and ethylene-propylene-diene copolymer; polybutene; and polypentene.

Specific examples of the polyolefin resin include, in addition, ethylene-vinyl acetate copolymer (EVA), ethylene-ethyl acrylate copolymer, polyketone, and copolymers produced with a metallocene catalyst. Also included are chemically reacted and modified compounds of these polymers, specifically ionomer resins, saponified EVA, and olefin elastomers produced using dynamic vulcanization in an extruder.

As the polyolefin resin, polyethylene-based resin and polypropylene-based resin are preferable, and polypropylene-based resin is more preferable. The stereo-regularity of the structure derived from propylene in polypropylene-based resins may be isotactic, syndiotactic, or atactic. Polypropylene is further preferred as a polypropylene-based resin.

The polyolefin resin contained in the resin composition may be one or more than one type. The polyolefin resins may be commercially available.

The content of the polyolefin resin in the resin composition of the present invention is the amount obtained by subtracting the contents of the above-mentioned component (A), component (B), component (C), and optionally other components from the resin composition. The content of the polyolefin resin in the total amount of the resin composition may be, for example, in the range of 20 to 90 mass %, and more preferably in the range of 30 to 80 mass %.

### (Other Resins)

The resin composition of the present invention may contain other resins than polyolefin resins. Other resins are, for example, thermoplastic resins. Specific examples include polystyrene resins, acrylonitrile-butadiene-styrene copolymers (ABS resins), and polycarbonate resins and polyester resins such as polyethylene terephthalate. One or more of these may be used alone or in combination. As the other resin, a commercially available product may be used.

Further, as the other resin, a resin that functions as a toughening agent may be used. The toughening agent is used for the purpose of improving the flexibility, processability, and impact resistance, of the resin composition. For example, it is a resin having rubber elasticity. As mentioned above, the addition of a toughening agent is expected to reduce stiffness as a side effect. Therefore, when using the product, the content is preferably adjusted so as not to impair the effect of the present invention.

The resin used as a toughening agent is preferably a thermoplastic elastomer containing a soft segment composed of a polymer of a monomer containing butadiene and a hard segment composed of a polymer of a monomer having an aromatic group such as styrene. Examples of the above thermoplastic elastomers include methyl methacrylate-butadiene-styrene copolymer (MBS), acrylonitrile-butadiene styrene-styrene copolymer (ABS), styrene-butadiene styrene copolymer (SBS), and butyl acrylate-methyl methacrylate copolymers. Above all, it is preferable that the toughening agent is one or more selected from the group consisting of MBS and ABS from the viewpoint of the compatibility and flame retardancy of the resin composition and the dispersibility of the thermoplastic elastomer in the resin composition. The toughening agent may be used alone or in combination of two or more.

The amount of other resins in the resin composition of the present invention is, for example, 0 to 20 parts by mass per 100 parts by mass of polyolefin resin. More preferably, the range may be set to 0 to 10 parts by mass, and it is especially preferred that no other resin is included.

### (Component (A))

Component (A) is at least one selected from the group consisting of aluminum hydroxide, magnesium hydroxide, and a phosphorus compound. Hereafter, aluminum hydroxide and magnesium hydroxide may be referred to as component (A1), and a phosphorus compound as component (A2). In the resin composition of the present invention, component (A) acts primarily as a flame retardant.

The content of component (A) is 10 to 60 mass % of the total amount of the resin composition of the invention. When the content of component (A) is less than 10 mass %, the flame retardancy of the injection molded product is insufficient, and when the content exceeds 60 mass %, the mechanical strength, especially impact strength, of the injection molded product is insufficient. The content of component (A) relative to the total amount of resin composition is preferably in the range of 10 to 45 mass %, and more preferably, in the range of 10 to 25 mass %.

The phosphorus content relative to the total amount of the resin composition is 5 mass % or less. In the resin composition of the present invention, it is an essential requirement that the content of component (A) is within the above range and that the phosphorus content is 5 mass % or less of the total amount thereof. The phosphorus content relative to the total amount of the resin composition is preferably 2 mass % or less, 1 mass % or less is more preferred, and 0 mass % is even more preferred.

The phosphorus content (mass %) relative to the total amount of the above resin composition may be measured, for example, by using an energy dispersive X-ray fluorescence analyzer (e.g., JSX-1000S (manufactured by JEOL Ltd.).

The phosphorus compound, component (A2), has poor compatibility with a polyolefin resin and tends to separate during melting, and the separated material bleeds out and remains on the surface of the molded product, resulting in a poor appearance. When the phosphorus content to the total amount of the resin composition is 5 mass % or less, the deterioration of appearance caused by the bleed-out of component (A2) may be suppressed.

In component (A), the mass ratio of the content of component (A1) to component (A2) is preferably in the range of 100:0 to 30:70, more preferably in the range of 100:0 to 50:50, and still more preferably in the range of 100:0 to 75:25. When the mass ratio of the content of component (A1) to component (A2) is in the above range, the generation of burrs in continuous production in injection molding is suppressed and the quality of the molded product is easily maintained.

The resin composition of the present invention is a resin composition for injection molding. In the injection molding, as the molten resin composition fills the mold cavity, air that is originally in the cavity, decomposition gases of organic components in the resin composition that are generated when it stays in the cylinder, and decomposition gas generated by shear heat generation is adiabatically compressed at the final filling portion, resulting in significant heat generation and accompanying decomposition. To prevent this, air vents are installed, for example, in the final filling section of the mold to provide a gas escape. In particular, since the decomposition product of the phosphorus compound is acidic, when the resin composition contains the phosphorus compound, the high temperature air vent portion is easily corroded. As corrosion progresses in the air vent portion, the thickness of the air vent portion gradually expands, leading to the generation of burrs in the molded product.

By setting the mass ratio of the contents of component (A1) and component (A2) to the above range, the content of the phosphorus compound in the resin composition may be relatively low, and as a result, the corrosion of the air vent portion is suppressed. As a result, the effect of suppressing the generation of burrs in the injection molded product is particularly remarkable.

### <Component (A1)>

Component (A1) is aluminum hydroxide or magnesium hydroxide. Only aluminum hydroxide or only magnesium hydroxide may be used as component (A1), or both may be used. As described above, the ratio of component (A1) in component (A) is preferably 30 to 100 mass %, more preferably 50 to 100 mass %, and still more preferably 75 to 100 mass %.

Particles are preferred as the form of component (A1). The shape of particles is not restricted, and includes spherical, spindle, plate, scale, needle, and fiber forms. When component (A1) is a particle, the aspect ratio, measured in the same manner as component (C), is less than 10.

Component (A1) in the resin composition preferably has an average particle diameter in the range of 0.01 to 100 μm, more preferably in the range of 0.1 to 10 μm, and still more preferably in the range of 0.2 to 2 μm. The average particle diameter of the component (A1) may be treated as the same as the primary particle diameter of aluminum hydroxide or magnesium hydroxide particles (hereinafter, also referred to as “raw material particles”) used in the production of the resin composition. The primary particle diameter of the raw material particles as measured by laser diffraction and scattering may be measured as the median diameter (D50) on a volume basis.

The raw material particles of component (A1) may be surface-modified by a surface modifier if necessary. Examples of the surface modifier that may be used for surface modification include alkylsilazane compounds such as hexamethyldisilazane (HMDS), dimethyldimethoxysilane, dimethyldiethoxysilane, and alkylalkoxysilanes such as trimethylmethoxysilane, methyltrimethoxysilane, and butyltrimethoxysilane, chlorosilanes such as dimethyldichlorosilane and trimethylchlorosilane, silicone oil, silicone varnish, and various fatty acids. One of these surface modifiers may be used alone, or a mixture of two or more may be used.

### <Component (A2)>

Component (A2) is a phosphorus compound. Component (A2) may be used without restriction as long as it is a phosphorus-containing compound. When component (A2) is used as component (A) as described above, it is used so that the phosphorus content relative to the total amount of the resin composition is 5 mass % or less. As described above, the phosphorus content with respect to the total amount of the resin composition is preferably 2 mass % or less, more preferably 1 mass % or less, still more preferably 0% by mass. From this viewpoint, the ratio of component (A2) in component (A) is preferably 0 to 70 mass %, more preferably 0 to 50 mass %, and still more preferably 0 to 25 mass %.

Examples of the phosphorus compound include metal or ammonium salts of phosphinic acid, phosphonic acid, and phosphoric acid; and esters of phosphine acid, phosphonic acid, and phosphoric acid. Among these, phosphate ester compounds (to be described in detail later) are preferred as component (A2) from the viewpoint of flame retardant effects.

Specific examples of the above-described salt include phosphinic acid metal salts, particularly aluminum phosphinate and zinc phosphinate; metal phosphonates, particularly aluminum phosphonate, calcium phosphonate, and zinc phosphonate. Further, examples thereof include hydrates of metal phosphonates, ammonium phosphate, and ammonium polyphosphate.

Examples of the phosphinate ester compound include dimethylphosphinic acid, methylethylphosphinic acid, methylpropylphosphinic acid, diethylphosphinic acid, dioctylphosphinic acid, phenylphosphinic acid, diethylphenylphosphinic acid, diphenylphosphinic acid and bis(4-methoxyphenyl)phosphinic acid.

Examples of the phosphonate ester compound include methylphosphonic acid, dimethyl methylphosphonate, diethyl methylphosphonate, ethylphosphonic acid, propylphosphonic acid, butylphosphonic acid, 2-methyl-propylphosphonic acid, t-butylphosphonic acid, and 2,3-dimethylbutylphosphonic acid, octylphosphonic acid, phenylphosphonic acid, and dioctyl phenylphosphonate.

As the phosphorus compound other than the above, the following compounds may be used as component (A2). Examples thereof include 9,10-dihydro-9-oxa-10-phosphaphenanthrene 10-oxide (DOPO) derivatives, polyphosphonates (Nofia™ HM1100, manufactured by FRXPolymers, Chelmsford, USA), zinc bis(diethyl phosphinate), aluminum tris(diethyl phosphinate), melamine phosphate, melamine pyrophosphate, melamine polyphosphate, melamine poly(aluminum phosphate), melamine poly(zinc phosphate), methylphosphonate melamine salt, guanylurea phosphate, guanidine phosphate, ethylenediamine phosphate, and phosphazene compounds such as phenoxyphosphazene oligomers.

One of these phosphorus compounds may be used alone as component (A2), or two or more may be used in combination.

### [Phosphate Ester Compound]

The phosphate ester compound may be aliphatic or aromatic phosphate ester compounds, with aromatic phosphate ester compounds being preferred. When aromatic phosphate ester compounds are used as component (A), a NOR-type HALS is thought to generate radicals more stably, making it easier to achieve the flame retardant effect.

The phosphate ester compounds include monomeric phosphate ester compounds obtained by reacting phosphoric acid with an aliphatic or an aromatic alcohol, and aromatic condensed phosphate ester compounds, which are reaction products of phosphorus oxychloride with a divalent phenolic compound and phenol (or an alkyl phenol).

Specific examples of the phosphate ester compound include trimethyl phosphate (TMP), triethyl phosphate (TEP), tributyl phosphate, triphenyl phosphate (TPP), tricresyl phosphate (TCP), trixylenyl phosphate (TXP), cresyldiphenyl phosphate (CDP), tris(2,4-di-t-butylphenyl) phosphate, distearyl pentaerythritol diphosphate, bis(2,6-di-t-butyl-4-methylphenyl)pentaerythritol diphosphate, bis(2,4-di-t-butylphenyl)pentaerythritol diphosphate, resorcinol bis-dixylenyl phosphate, resorcinol bis-diphenyl phosphate, bisphenol A bis-diphenyl phosphate (BADP), bisphenol A bis-dicresyl phosphate, bisphenol A bis-diphenyl phosphate, and bisphenol A bis-dixylenyl phosphate.

The phosphate ester compound is preferably a condensed phosphate ester compound, which is a condensation type, from the viewpoint of heat resistance. Examples of the condensed phosphate compound include aromatic condensed phosphate ester compounds represented by the following chemical formula (A2).

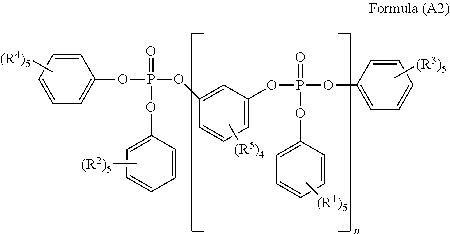

In the above Formula (A2), R¹ to R⁵ each independently represent a hydrogen atom, an alkyl group having carbon atoms of 1 to 10, a cycloalkyl group having carbon atoms of 3 to 20, an aryl group having carbon atoms of 6 to 20, an alkoxy group having carbon atoms of 1 to 10, or a halogen atom, and R¹ to R⁵ may be the same or different. The plurality (5) of R¹ present may be identical or different from each other. The same is true for R², R³, R⁴ and R⁵ present in plurality (4 to 5), respectively. n is an integer of 1 to 30, preferably n is an integer of 1 to 10.

Examples of the alkyl group include a methyl group, an ethyl group, a propyl group, an isopropyl group, a butyl group, an isobutyl group, a sec-butyl group, a tert-butyl group, an amyl group, a tert-amyl group, a hexyl group and a 2-ethylhexyl group, an n-octyl group, a nonyl group, and a decyl group.

Examples of the cycloalkyl group include a cyclohexyl group. Examples of the aryl group include a phenyl group, a cresyl group, a xylyl group, a 2,6-xylyl group, a 2,4,6-trimethylphenyl group, a butylphenyl group, and a nonylphenyl group.

Examples of the alkoxy group include a methoxy group, an ethoxy group, a propoxy group, and a butoxy group. Examples of the halogen atom include a fluorine atom, a chlorine atom, and a bromine atom.

An aromatic condensed phosphate ester compound is a reaction product of phosphorus oxychloride, a divalent phenolic compound and phenol (or alkylphenol) as described above, and an aromatic condensed phosphate ester compound whose structure is represented by Formula (A2) is a compound when the divalent phenolic compound is resorcinol which may have a substituent (hereinafter, also referred to as a “resorcinol compound”). The aromatic condensed phosphate ester compound may be a compound obtained by using 4,4′-biphenol and bisphenol A (each may have a substituent) instead of the resorcinol compound. Specifically, in Formula (A2), an aromatic condensed phosphate ester compound having a 4,4′-biphenol residue or a bisphenol A residue, each of which may have a substituent, instead of the resorcinol compound residue, may be used in the present invention.

Commercial phosphate compounds may be used. As commercially available phosphate ester compounds, for example, PX-200 (resorcinol bis-dixylenyl phosphate), and CR-733S (resorcinol bis-diphenyl phosphate) manufactured by Daihachi Chemical Industry Co., Ltd. may be used.

### (Component (B))

Component (B) is a NOR-type HALS. The content of component (B) is 0.05 to 5 mass % of the total amount of the resin composition of the present invention. As described above, component (B) has the effect of decreasing the melt viscosity of the resin composition during injection molding, and thereby the resin composition of the present invention is said to have the effect of suppressing mold wear. When the content of component (B) is less than 0.05 mass %, the effect of suppressing mold wear when used for injection molding is not sufficient. When the content of component (B) is more than 5 mass %, the mechanical strength, especially bending strength, of the injection molded product is not sufficient. The content of component (B) relative to the total amount of resin composition is preferably in the range of 0.1 to 2 mass %, and more preferably in the range of 0.2 to 1 mass %.

Component (B), along with the above effects, imparts flame retardancy to the injection molded product. The NOR-type HALS is also a well-known light stabilizer, and its addition may also impart light resistance to the injection molded product.

The NOR-type HALS is a HALS (hindered amine light stabilizer) having an alkoxyimino group (>N—(OR). The NOR-type HALS has a structure of an N-alkoxy group which is made by replacing H in the NH portion of the imino group (>NH) with an alkoxy group. On the other hand, in the NH-type HALS, H in the NH portion of the imino group remains as H, and in the NR-type HALS, H in the NH portion of the imino group is replaced with an alkyl group R (same meaning as R in the alkoxy group), typically replaces with a methyl group. This N-alkoxy group traps alkyl peroxy radicals (RO₂.), which readily become radicals and exhibit flame retardant effects. In addition, in the resin composition of the present invention, it functions to inhibit the above-mentioned mold wear.

On the other hand, in the case of an NR-type hindered amine compound, typically an N-methyl-type hindered amine compound or an NH-type hindered amine compound, the function of suppressing mold wear is poor, and the flame retardant effect is also low.

R in the above alkoxy group (—OR) represents a substituted or unsubstituted saturated or unsaturated hydrocarbon group. Examples of R include an alkyl group, an aralkyl group, and an aryl group. The alkyl group may be linear, branched-chain or cyclic, or a combination of these.

The NOR-type HALS used in the present invention is not particularly limited as long as it has an alkoxyimino group (>N—OR) structure. Specific suitable examples thereof include the NOR-type HALS described in JP-A 2002-507238, WO 2005/082852, and WO 2008/003605.

Examples of the NOR-type HALS include compounds having a structure represented by the following formula (B).

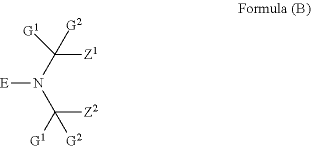

In Formula (B), G¹ and G² independently represent an alkyl group having 1 to 4 carbon atoms or a pentamethylene group by combining together. Z¹ and Z² each represent a methyl group, or Z¹ and Z² form a crosslinked moiety by combining together. The crosslinked moiety may be further attached to an organic group via an ester group, an ether group, an amide group, an amino group, a carbonyl group or a urethane group. E represents an alkoxy group having 1 to 18 carbon atoms, a cycloalkoxy group having 5 to 12 carbon atoms, an aralkoxy group having 7 to 25 carbon atoms, or an aryloxy group having 6 to 12 carbon atoms.

As the NOR-type HALS represented by Formula (B), a polymer type is preferable. The polymer type is generally an oligomer or polymer compound. The polymeric type is superior in terms of flame retardancy and heat resistance. The oligomer or polymer compound in the polymer type compound preferably has a repeating unit number of 2 to 100, more preferably 5 to 80.

Further, as the NOR-type HALS represented by Formula (B), for example, a compound represented by the following Formula (1) may be used.

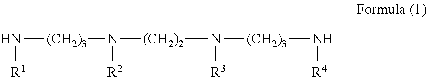

In Formula (1), R¹ to R⁴ each respectively represent a hydrogen atom or an organic group of Formula (2) below. At least one of R¹ to R⁴ represents an organic group of Formula (2) below.

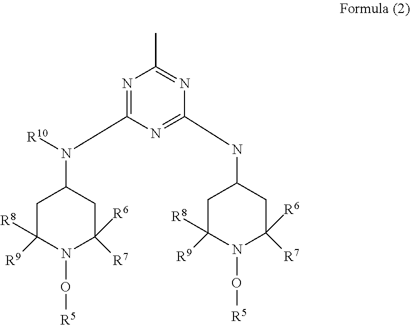

In the formula, R⁵ represents an alkyl group having 1 to 17 carbon atoms, a cycloalkyl group having 5 to 10 carbon atoms, a phenyl group or a phenylalkyl group having 7 to 15 carbon atoms. R⁶, R⁷, R⁸ and R⁹ each represent an alkyl group having 1 to 4 carbon atoms. R¹⁰ represents a hydrogen atom or a linear or branched-chain alkyl group having 1 to 12 carbon atoms.

Among the alkyl groups having 1 to 17 carbon atoms which are represented by R⁵, a methyl group, a propyl group or an octyl group is preferable. Among the cycloalkyl groups having 5 to 10 carbon atoms, a cyclohexyl group is preferable. Among the phenyl group or phenylalkyl groups having 7 to 15 carbon atoms, a phenyl group is preferable.

Among the alkyl groups having 1 to 4 carbon atoms which are represented R⁶ to R⁹, a methyl group is preferable. Among the linear or branched-chain alkyl groups having 1 to 12 carbon atoms which are represented by R10, an n-butyl group is preferable.

In the compounds represented by Formula (1), those in which R¹, R², and R³ are an organic group of Formula (2), or those in which R¹, R², and R⁴ are an organic group of Formula (2) are preferable.

Examples of the NOR-type HALS include the following compounds: 1-cyclohexyloxy-2,2,6,6-tetramethyl-4-octadecylaminopiperidine; bis(1-octyloxy-2,2,6,6-tetramethylpiperidine-4-yl) sebacate; 2,4-bis[(1-cyclohexyloxy-2,2,6,6-tetramethylpiperidine-4-yl) butylamino]-6-(2-hydroxyethylamino)-s-triazine; bis(1-cyclohexyloxy-2,2,6,6-tetramethylpiperidin-4-yl) adipate; an oligomer compound that is a condensation product of 4,4′-hexamethylenebis(amino-2,2,6,6-tetramethylpiperidine) with 2-chloro-4,6-bis(dibutylamino)-s-triazine-terminated 2,4-dichloro-6-[(1-octyloxy-2,2,6,6-tetramethylpiperidine-4)-yl)butylamino]-s-triazine; an oligomer compound that is a condensation product of 4,4′-hexamethylenebis(amino-2,2,6,6-tetramethylpiperidine) with 2-chloro-4,6-bis(dibutylamino)-s-triazine-terminated 2,4-dichloro-6-[(1-cyclohexyloxy-2,2,6,6-tetramethylpiperidine-4)-yl)butylamino]-s-triazine; 2,4-bis[(1-cyclohexyloxy-2,2,6,6-piperidine-4-yl)-6-chloro-s-triazine; a reaction product of peroxidized 4-butylamino-2,2,6,6-tetramethylpiperidine with 2,4,6-trichloro-s-triazine, cyclohexane, and N, N′-ethane-1,2-diylbis(1,3-propanediamine) (N, N′, N′″-tris{2,4-bis[(1-cyclohexyloxy-2,2,6,6-tetramethylpiperidine-4-yl) n-butylamino]-s-triazine-6-yl}-3,3′-ethylenediiminodipropylamine); bis(1-undecanoxy-2,2,6,6-tetramethylpiperidine-4-yl) carbonate; 1-undecyloxy-2,2,6,6-tetramethylpiperidine-4-one; bis(1-stearyloxy-2,2,6,6-tetramethylpiperidine-4-yl) carbonate.

A commercially available product may be used for the NOR-type HALS. Examples of the commercially available NOR-type HALS include Flamestab NOR116FF, NOR116FF, TINUVIN NOR371, TINUVIN XT 850FF, TINUVIN XT 855FF, and TINUVIN PA 123 (manufactured by BASF, Inc.); and LA-81 and FP-T (manufactured by ADEKA, Inc.). The NOR-type HALS may be used alone or in combination with two or more types.

### (Component (c))

Component (C) is a fibrous filler having an aspect ratio of 10 or higher. The aspect ratio in component (C) is the average aspect ratio obtained by the following method. Hereinafter, the fibrous filler having an aspect ratio of 10 or more is sometimes referred to as a fibrous filler (C).

### <Measuring Method of Aspect Ratio>

The aspect ratio of the fibrous filler is expressed as the value obtained by dividing the fiber length (length of the fiber) in the fibrous filler by the fiber diameter (the smallest diameter of the cross section perpendicular to the longitudinal direction of the fiber, i.e., the minimum diameter of the fiber thickness). In the present invention, for the fibrous filler in the resin composition, the fiber length and the fiber diameter of 100 fibrous fillers are measured, the aspect ratio of each fibrous filler is obtained, and the average value (average aspect ratio) of the 100 fibers is calculated and used as the aspect ratio.

The shape of the fibrous filler used as a raw material in the manufacture of the resin composition changes as the resin compositions go through the production process, such as kneading, milling, and molding. For example, the raw material fibrous filler often breaks and changes its fiber length during the production process. Therefore, in the present invention, the aspect ratio of the fibrous filler is calculated by measuring the fiber length and diameter of the fibrous filler present in the resin composition.

Specifically, the resin composition is heated in an electric furnace to burn off the resin including polyolefin resin, the organic content in component (A), and the organic content in component (B). The fibrous filler is removed from the inorganic residue. The heating temperature is preferably the temperature at which the above organic content may be burned at 500° C. or higher, for example. The inorganic content of the residue includes the inorganic content in component (A) and the fibrous filler. The inorganic content in component (A) is distinguishable from the fibrous filler because it is not fibrous in shape. The selection of 100 fibrous fillers from the inorganic fraction is done randomly. The constituent material of component (C), fibrous filler (C), is an inorganic material.

The fiber length and fiber diameter are measured by observing the predetermined number of fibrous fillers in the resin composition thus obtained with a scanning electron microscope, a transmission electron microscope, and an atomic force microscope.

The aspect ratio of the fibrous filler (C) is 10 or more. An aspect ratio of 20 or more is preferred, and an aspect ratio of 50 or more is still more preferred. When a fibrous filler having an aspect ratio of less than 10 is used, sufficient mechanical strength, especially bending strength, may not be obtained in the injection molded product of the resin composition. The aspect ratio of the fibrous filler (C), for example, from the viewpoint of fluidity of the resin during injection molding, is preferably less than 500, and 100 or less is more preferred.

The average fiber length of the fibrous filler (C) determined by the above method is preferably, for example, 0.01 to 1 mm, and more preferably, it is 0.02 to 0.5 mm. The average fiber diameter of the fibrous filler (C) is preferably, for example, 0.001 to 0.05 mm, and more preferably, it is 0.005 to 0.02 mm.

The average fiber length and average fiber diameter of the fibrous filler (C) may also be nano-sized, as described in the halloysite described below.

The content of component (c) is 1 to 20 mass % of the total amount of the resin composition of the present invention. When the content of component (C) is less than 1 mass %, the mechanical strength, especially bending strength, of the injection molded product is not sufficient, and when the content is more than 20 mass %, the effect of controlling mold wear when used for injection molding is not sufficient. The content of component (C) relative to the total amount of resin composition is preferably in the range of 2 to 15 mass %, and more preferably, it is 5 to 10 mass %.

Examples of the fibrous filler (C) include glass fiber, carbon fiber, carbon nanotube, metal fiber, mineral fiber, ceramic fiber, rock wool, wollastonite, potassium titanate, barium titanate, sepiolite, halloysite, and imogolite having an aspect ratio of 10 or more. One of these fibrous fillers (C) may be used alone, or two or more may be used in combination.

As the fibrous filler (C), halloysite having an aspect ratio of 10 or more is preferred from the viewpoint of suppressing mold wear. Halloysite is represented by the composition A1₂Si₂O₅(OH)₄. Typically, it is available as a tubular nano-filler having a fiber diameter of several tens of nm and a fiber length of several hundreds to several thousand nm. Halloysite is known for its unique features such as high gas adsorption due to its nano-sized and highly active internal Al(OH) structure.

When halloysite is used as the fibrous filler (C), the above described effects of inhibiting corrosion at the air vent of injection molding dies and inhibiting the generation of burrs and other defects in the injection molded product are particularly pronounced.

The fibrous filler used in the manufacture of resin compositions (hereinafter also referred to as “raw material fibrous filler” to distinguish it from fibrous filler (C) in the resin composition).) is used, for example, with a larger aspect ratio than the fibrous filler (C), depending on the constituent material of the fibrous filler, in consideration of folding in the production process. For example, when the raw fibrous filler made of constituent materials that are expected to break during the production process, an aspect ratio of 20 or higher is preferable, and an aspect ratio of 100 or more is more preferable.

It is preferable that the raw material fibrous filler is pretreated with a coupling agent such as an isocyanate compound, an organic silane compound, an organic titanate compound, an organic borane compound, or an epoxy compound before use. It is preferable in the sense of obtaining better mechanical strength.

### (Other Additives)

The resin composition of the present invention may contain, in addition to the resin containing the polyolefin resin, component (A), component (B), and component (C), a component known as an additive to the extent that the effect of the present invention is not impaired. Examples of other additive include other flame retardant other than component (A) and component (B), a drip inhibitor, an antioxidant, and a lubricant.

### <Other Flame Retardants>

Other flame retardants may be organic or inorganic flame retardants. Examples of the organic flame retardant include brominated compounds. Examples of the inorganic flame retardant include antimony compounds and metal hydroxides other than component (A1).

### <Drip Inhibitor>

The drip inhibitor is added for the purpose of preventing the resin material from dripping (drip) during combustion and improving the flame retardancy. Examples of the drip inhibitor include a fluorine-based drip inhibitor, a silicone rubber, and a layered silicate. The drip inhibitor may be used alone or in combination of two or more.

### <Antioxidant>

Examples of the antioxidant include a hindered phenol.

### <Lubricant>

Examples of the lubricant include a fatty acid salt, a fatty acid amide, a silane polymer, a solid paraffin, a liquid paraffin, calcium stearate, zinc stearate, stearic acid amide, silicone powder, methylene bisstearic acid amide and N,N′-ethylene bisstearic acid amide. One or more of these may be selected.

The content of other additives in the resin composition of the present invention is within the range that does not impair the effect of the present invention, for example, it is in the range of 0.1 to 30 mass % of the total resin composition. More preferably, it is in the range of 0.1 to 20 mass %. A total of 30 mass % or less is also preferable.

### [Production Method of Resin Composition]

The resin composition of the present invention may be obtained by melt kneading the following so as to obtain the above-mentioned resin composition of the present invention. The material to be melt-kneaded are the resin containing the above-described polyolefin, component (A), component (B), component (C), and other additives that may be included as required. In particular, in component (C), the aspect ratio may change (decrease) from raw fibrous filler to fibrous filler (C) during the production process.

The resin composition of the present invention is preferably produced by applying the production method containing a first step of melt kneading the polyolefin resin, component (A), and component (B) to obtain a resin mixture, depending on the constituent material of the raw fibrous filler, taking into consideration the above aspect ratio change, for example; and a second step of melt kneading the resin mixture and a raw material of the fibrous filler having an aspect ratio of 10 or more.

When the resin composition contains other resins or other additives, the other resins or other additives may be melt-kneaded in the first step or melt-kneaded in the second step.

In the above method, pellets obtained by melt kneading raw fibrous filler with polyolefin resin or other resin may be used. The polyolefin resin contained in the resin composition need only be melt-kneaded at least in part in the first step, and the remainder may be added and melt-kneaded in the second step if necessary. The same is true for component (A) and component (B).

In the production method of the present invention, melt kneading in the first and second steps is performed using kneading equipment such as a Banbury mixer, a roll mixer, a plastograph, an extruder (single-screw extruder, a multi-screw extruder (for example, a twin-screw extruder)), and a kneader, for example. Among these, melt kneading using an extruder is preferred because of its high production efficiency. Furthermore, it is preferable to use a multi-screw extruder for melt kneading because of its ability to impart high shear properties, and it is more preferable to use a twin-screw extruder. The term extruder is used here in the category including extrusion kneading machines.

In the production process, different kneading equipment may be used for the first step and the second step, but it is preferable to use an extruder, especially a twin-screw extruder, for both processes.

The temperature during melt kneading (melt kneading temperature) is preferably above the melting temperature of the polyolefin resin in both the first step and the second step. For example, a melt kneading temperature of 150 to 280° C. is preferred, and is selected according to the polyolefin resin used. When a polypropylene resin is used as a polyolefin resin, a melt kneading temperature of 180 to 270° C. is preferred. More preferably, the temperature is 180 to 230° C. Within the above temperature range, the melt kneading temperatures in the first step and the second step may be the same or different. When an extruder is used for melt kneading, the kneading melt temperature corresponds to the cylinder temperature.

When an extruder is used for melt kneading, a preferable screw speed is 50 to 30 0 rpm both in the first step and the second step. The screw speed in the first step and the second step may be the same or different. The discharge rate of the resin mixture or resin composition from the extruder in the first step and the second step is preferably in the range of 1 to 50 kg/hr.

In the present invention, the first step and the second step may be performed continuously using the same extruder, which is preferred from the viewpoint of productivity. For example, using a twin-screw extruder, raw material components other than the raw material fibrous filler are fed from a hopper installed at the very end of the cylinder of the twin-screw extruder, and the raw material fibrous filler is fed from a side feeder installed at the front of the cylinder, for example, in the center, so that the first step and the second step may be performed continuously. The front-most end of the cylinder is the discharge section of the resin composition, and the last section corresponds to the area near the end of the cylinder opposite the discharge section.

The components may be pre-mixed (dry blended) using various mixers, such as a high-speed mixer known as a tumbler or a Henschel mixer, for example, prior to the melt kneading in the first step.

In the production method of the present invention, after extruding the kneaded material into strands in the second step, the stranded extruded kneaded material may be processed into pellets, flakes, or other forms.

The resin composition may take various forms such as powder, granule, tablet, pellet, flake, fiber, and liquid.

Using the resin composition of the present invention, an injection molded product may be produced economically with stable quality, for example, in continuous production over a long period of time, with wear of the gate section of the mold and corrosion of the air vent portion being suppressed. In addition, the injection mold sectioned product obtained by using the resin composition of the present invention have excellent appearance, mechanical strength (rigidity and toughness), and flame retardancy.

For example, the injection molded product molded from the resin composition of the present invention preferably has a bending strength of 25 MPa or more, more preferably 35 MPa or more, as measured in a bending test carried out according to JIS-K7171. Still more preferably, it is 50 MPa or more. When the bending strength is 25 MPa or higher, the rigidity of the molded product may be evaluated as being safe for practical use.

For example, the injection molded product molded from the resin composition of the present invention preferably has a Charpy impact strength of 8 kJ/m² or more measured in a Charpy impact test (with a notch) carried out according to JIS-K7110. It is more preferably 15 kJ/m² or more, and still more preferably 20 kJ/m² or more. When the Charpy impact strength is 8 kJ/m² or more, the toughness of the molded product may be evaluated to be acceptable for practical use.

Here, flame retardancy is one of the properties of flame resistance, which refers to the property of slow burning but continuing to burn to some extent. There are JIS, ASTM, and other standards for evaluating flame retardancy. In general, the UL standard is particularly emphasized. The UL standard is a standard established by “Underwriters Laboratories Corporation” in the United States and evaluated by the company.

In the injection molded product molded from the resin composition of the present invention, when evaluated by the above UL standards as a test piece of a predetermined size, in the UL-94 compliant combustion test, it is preferable to be determined as V-2 or higher, more preferable to be determined as V-1 or higher, and even more preferable to be determined as V-0.

### (Molded Product)

An injection molded article may be produced using the resin composition of the present invention. By using this injection molded product, as described above, it is possible to obtain a product having excellent appearance, mechanical strength (rigidity and toughness), and flame retardancy.

Conventional injection molding machines may be used to produce an injection molded product. An injection molded product may be produced, for example, by melting the resin composition in a cylinder, injecting the melted resin composition into a mold, and then cooling the mold. The injection speed and pressure are appropriately adjusted. For example, the preferred conditions for injection molding are as follows: cylinder temperature (melt temperature) 180 to 230° C., injection speed 30 to 200 mm/sec, pressure 500 to 1000 kgf/cm², and mold temperature 40 to 80° C.

The fiber length, fiber diameter, and aspect ratio of the fibrous filler in the injection-molded product may be measured or calculated in the same manner as for the fibrous filler in the resin composition described above. The fiber length, fiber diameter, and aspect ratio of the fibrous filler in the injection-molded product obtained by using the resin composition of the present invention are preferably within the range in which the effect of the present invention may be fully demonstrated. Specifically, the average fiber length of the fibrous filler is preferably in the range of 0.01 to 1 mm, and the average fiber diameter is preferably in the range of 0.001 to 0.05 mm, and the average aspect ratio is preferably in the range of 10 to 100.

The average fiber length and average fiber diameter of the fibrous filler may be nano-sized as described in the above-described halloysite.

The injection molded products that are injection molded from the resin composition of the present invention are not particularly limited. Examples thereof include electrical and electronic parts, electrical components, exterior parts, and interior parts in the fields of home appliances and automobiles, as well as various packaging materials, household goods, office supplies, piping, and agricultural materials.

### EXAMPLES

Hereinafter, the present invention will be specifically described with reference to examples, but the present invention is not limited thereto. In addition, although the description of “parts” or “%” is used in the examples, it represents “parts by mass” or “mass %” unless otherwise specified.

### Resin Compositions; Examples 1 to 18, Comparative Examples 1 to 8

The following commercial products were prepared as raw material components to be included in the resin compositions in each of the examples and comparative examples.

### <Resin>

Polypropylene resin: Prime Polypro J715M (product name, manufactured by Prime Polymer Co., Ltd.)

Polyethylene resin: HJ560 (product name, manufactured by Japan Polyethylene Corporation)

### <Component (A1)>

Aluminum hydroxide: KH-101 (product name, manufactured by KC Corporation, particles having an average primary particle diameter of 1.0 μm)

Magnesium hydroxide: MAGSEEDS N-6 (product name, manufactured by Konoshima Chemical Industry Co. Ltd., particles having an average primary particle diameter of 1.2 m and modified with higher fatty acid)

### <Component (A2)>

Phosphate ester compound: PX-200 (product name, manufactured by Daihachi Chemical Industry Co. Ltd., Resorcinol bis-dixylenyl phosphate)

Ammonium polyphosphate: TAIEN K (product name, manufactured by Taihei Chemical Industry Co., Ltd.)

Phosphonate metal salt: Calcium phosphonate (manufactured by Kanto Chemical Co., Ltd.)

### <Component (B)>

NOR-type HALS: Flamestab NOR116FF: (product name, manufactured by BASF Corporation, N, N′, N′″-tris{2,4-bis [(1-cyclohexyloxy-2,2,6,6-tetramethylpiperidine-4-yl) n-butylamino]-s-triazine-6-yl}-3,3′-ethylenediiminodipropylamine)

<HALS other than component (B)>

NH-type HALS: Tinuvin 770DF (manufactured by BASF Corporation, bis(2,2,6,6-tetramethyl-4-piperidyl) sebacate)

NR(methyl)-type HALS: Tinuvin 765 (manufactured by BASF Corporation, mixture of bis(1,2,2,6,6-pentamethyl-4-piperidyl) sebacate and methyl-1,2,2,6,6-pentamethyl-4-piperidyl-sebacate)

### <Raw Material Fibrous Filler of Component (C)>

Glass fiber: ECS03T-430 (manufactured by Nippon Electric Glass Co., Ltd.; average fiber diameter 13 μm, average fiber length 3 mm)

Long glass fiber: FUNCSTER LR-24A (manufactured by Japan Polypropylene Corporation, Polypropylene master-batch pellet containing 40 mass % of long glass fiber; pellet length 10 mm was used.) In Table I and Table II, the amount of long glass fiber in the pellets (FUNCSTER LR-24A) blended in the resin composition is described in the column of component (C), and the polypropylene content is described in the column of resin component as the amount combined with the above J715M.

Halloysite: DRAGINITE APA: M (manufactured by FIMATEC Ltd.; average aspect ratio 18)

Wollastonite: WFC10 (manufactured by Nippon Talc Co., Ltd.; average aspect ratio 14)

Potassium titanate: TISMO D (manufactured by Otsuka Chemical Co., Ltd.; average aspect ratio 30)

Carbon fiber: Chopped carbon fiber HT C413 (manufactured by Teijin Ltd., average fiber diameter 7 μm, average fiber length 6 mm)

### (Production of Resin Compositions)

In each of the examples and comparative examples, each ingredient was used in the amounts (mass %) shown in Table I and Table II. In the column of content (mass %) of each component, a blank space indicates that the component in question is not contained.

Melt kneading was performed using a twin-screw extruder (“TEX30α” manufactured by Japan Steel Works, Ltd.) at a cylinder temperature of 200° C. and a screw rotation speed of 150 rpm. In all cases except Comparative Example 1, the raw material components except for the fibrous filler were dry-blended in advance and fed from a hopper installed at the very end of the twin-screw extruder cylinder, and the fibrous filler was fed from a side feeder installed in the center of the cylinder. For Comparative Example 1, all raw material components, including the fibrous filler, were dry-blended in advance and fed from the hopper installed at the very end of the twin-screw extruder cylinder. In the column of the production method of the resin composition of Table I and Table II, the term “Batch” is used for Comparative Example 1, and “Division” is used for all other examples except Comparative Example 1.

The strands discharged from the extruder were cut with a pelletizer and processed into pellets having a diameter of 2 mm and a length of 3 mm to obtain a resin composition.

### [Component Analysis in Resin Composition]

### (1) Measurement of Aspect Ratio of Fibrous Filler

The pellets of each resin composition obtained above were heated in an electric furnace at 600° C. for 4 hours, and the organic matter was incinerated to obtain a residue. From the residue, 100 fibrous fillers were randomly selected and observed with a scanning electron microscope (SEM) to measure the fiber length and fiber diameter, respectively. The aspect ratio of each fibrous filler was obtained, and the average value was calculated to obtain the average aspect ratio.

### (2) Measurement of Phosphorus Content (Mass %)

The phosphorus content was measured using the pellets of each resin composition obtained above. The phosphorus content (mass %) was determined using an energy dispersive X-ray fluorescence analyzer (JSX-1000S manufactured by JEOL Ltd.).

### <Evaluation>

The resin compositions of Examples 1 to 18 and the resin compositions of Comparative Examples 1 to 8 obtained above were evaluated as follows, and the mechanical strength (bending strength and impact strength), flame retardancy, continuous formability and the appearance of the molded product were evaluated. The results are shown in Table I and Table II.

### (Production Conditions of Test Pieces)

After the pellets of the resin compositions of each Example and Comparative Example were dried at 80° C. for 4 hours, a molded product for evaluation was molded by an injection molding machine (J140AD-110H, manufactured by Japan Steel Works, Ltd.). The cylinder temperature at the time of molding was 200° C., the injection pressure was 1000 kgf/cm² for the primary pressure, 500 kgf/cm² for the secondary pressure, the injection speed was 50 mm/sec, and the mold temperature was 50° C.

### (1) Measurement of Bending Strength

Under the above-mentioned molding conditions, a strip-shaped test piece of 80 mm×10 mm×4 mm was molded, a bending test was performed in accordance with JIS-K7171, the bending strength [MPa] was measured, and the evaluation was made according to the following criteria. When the bending strength was 25 MPa or higher, the strength of the molded product was judged to be acceptable for practical use.

### (Evaluation Criteria)

AA: 50 MPa or higher

BB: 35 MPa or higher, and less than 50 MPa

CC: 25 MPa or higher, and less than 35 MPa

DD: less than 25 MPa

### (2) Measurement of Impact Strength

Under the above-mentioned molding conditions, a strip-shaped test piece (with a notch) having a size of 80 mm×10 mm×4 mm was prepared according to JIS-K7110, and a Charpy impact test (with a notch) was performed.

The Charpy impact strength [kJ/m²] was measured and evaluated according to the following criteria. When the Charpy impact strength was 8 kJ/m² or more, it was judged that the toughness of the molded product was acceptable for practical use.

### (Evaluation Criteria)

AA: 20 kJ/m² or more

BB: 15 kJ/m² or more, and less than 20 kJ/m²

CC: 8 kJ/m² or more, and less than 15 kJ/m²

DD: less than 8 kJ/m²

### (3) Combustion Test (Evaluation of Flame Retardancy)

Under the molding conditions described above, a strip-shaped test piece having a size of 125 mm×12.5 mm×1.6 mm was prepared. Flammability tests were conducted in accordance with UL-94 and evaluated according to the following criteria. It was judged that there is no practical problem when the judgment of the combustion test is V-2 or higher.

### (Evaluation Criteria)

AA: Judgment is any one of V-0, V-1, and V-2.

BB: Judgment is less than V-2.

### (4) Continuous Formability

### (Continuous Molding Test)

In the mold for producing the bending test piece used for the evaluation of the bending strength, a nested gate portion was arranged at the end portion in the longitudinal direction. As the material of the nest, carbon steel S50C for machine structure was used. The gate size was 4 mm in width×1.5 mm in thickness, and the length of the land was 4 mm. Further, a nested air vent portion was provided at the end opposite to the gate portion. As the material of the nest, carbon steel S50C for machine structure was used. The size of the air vent was 4 mm in width×0.02 mm in thickness, and the length of the land was 1 mm. An air guide groove having a thickness of 2 mm was arranged from the end of the land toward the outer periphery of the mold.

Under the molding conditions described above, continuous molding tests were conducted for each of the resin compositions in the examples and comparative examples, in which the bending specimens were molded in 5,000 consecutive shots. For each resin composition of the examples and comparative examples, the nesting of the gate and air vent portions were replaced with new ones before starting molding, and then the same tests were conducted. When the cross-sectional area of the gate increases due to wear, it may lead to problems such as inconsistent quality and burr generation due to changes in the filling volume of the molded product.

(4-1) Change in Gate Cross-Sectional Area after Continuous Molding Test

After the continuous molding test, the nesting of the gate portion was removed and the width and thickness of the gate were measured with an optical microscope to determine the cross-sectional area ratio of the gate before the start of molding and after 5,000 shot molding (continuous molding test).

Gate cross-section area=Gate width×Gate thickness

Gate cross-sectional area ratio (AR)=Gate cross-sectional area after 5,000 molding shots/Gate cross-sectional area before the start of molding

### (Evaluation Criteria)

AA: Gate cross-sectional area ratio (AR)<1.002, (preferred level for practical use)

BB: 1.002≤Gate cross-sectional ratio (AR)<1.01, (not desirable but practically acceptable level)

CC: 1.01≤Gate cross-section ratio (AR), (level that causes practical problems)

(4-2) Burr Evaluation of Air Vent Portion after Continuous Molding Test

After the continuous molding test, the nesting of the air vent portion was removed, the appearance was visually observed, and the state of burrs on the molded product at the 5,000th shot was observed with an optical microscope.

### (Evaluation Criteria)

AA: No discoloration was observed in the air vent portion of the mold, and no burrs were observed in the air vent process portion of the molded product (very favorable level for practical use).

BB: Slight discoloration was observed in the air vent portion of the mold, but no burrs were observed in the air vent process portion of the molded product (favorable level for practical use).

CC: Discoloration was observed in the air vent portion of the mold, and slight burring was observed in the air vent processing portion of the molded product (not desirable, but at a level that is acceptable for practical use).

### (5) Appearance of Molded Product

In the above-mentioned bending test piece molding, the appearance of the molded product was visually confirmed and evaluated according to the following evaluation criteria.

### (Evaluation Criteria)

AA: No liquid adhesions were found on the surface of the molded product (favorable level for practical use).

BB: Liquid adhesion was observed on the surface of the molded product (level that causes practical problems).

TABLE I

| | Abbreviation of | | | | Example | Example | Example | Example | Example |
|---|---|---|---|---|---|---|---|---|---|
| | component | | Name of compound | Product name | 1 | 2 | 3 | 4 | 5 |
| Component | Resin [mass %] | | Polypropylene resin | PP in (J715M + | 69.0 | 69.0 | 69.0 | 69.0 | 69.0 |
| of | | | | LR-24A) | | | | | |
| Resin | | | Polyethylene resin | HJ560 | | | | | |
| composition | (A) | (A1) | Aluminum hydroxide | KH-101 | 10.0 | 10.0 | 10.0 | | |
| | | [mass %] | Magnesium hydroxide | N-6 | | | | 10.0 | 10.0 |
| | | (A2) | Phosphate ester | PX-200 | 10.0 | 10.0 | 10.0 | 10.0 | 10.0 |
| | | [mass %] | compound | | | | | | |
| | | | Ammonium | TAIEN K | | | | | |
| | | | polyphosphate | | | | | | |
| | | | Calcium phosphonate | — | | | | | |
| | | Total content of (A) [(A1) + (A2)] [mass %] | | | 20.0 | 20.0 | 20.0 | 20.0 | 20.0 |
| | | (A1):(A2) [mass ratio] | | | 50:50 | 50:50 | 50:50 | 50:50 | 50:50 |
| | | Phosphorous content [mass %] | | | 0.9 | 0.9 | 0.9 | 0.9 | 0.9 |
| | (B) [mass %] | | NOR-type HALS | NOR116FF | 1.00 | 1.00 | 1.00 | 1.00 | 1.00 |
| | HALS other | | NH-type HALS | Tinuvin 770DF | | | | | |
| | than (B) | | NR-type HALS | Tinuvin 765 | | | | | |
| | [mass %] | | | | | | | | |
| | (C) | (C) | Glass fiber | ECS03T-430 | 10.0 | | | | |
| | | [mass %] | Long glass fiber | Content of Long | | 10.0 | | | |
| | | | | glass fiber in | | | | | |
| | | | | LR-24A | | | | | |
| | | | Halloysite | APA:M | | | 10.0 | | |
| | | | Wollastonite | WFC10 | | | | 10.0 | |
| | | | Potassium titanate | TISMO D | | | | | 10.0 |
| | | | Carbon fiber | HTC413 | | | | | |

| | | | | | |
|---|---|---|---|---|---|
| Average aspect ratio in Resin composition | 15 | 60 | 18 | 10 | 20 |

| Production method of Resin composition | | | Division | Division | Division | Division | Division |
|---|---|---|---|---|---|---|---|
| Evaluation | Bending strength | | CC | BB | BB | CC | CC |
| result | Impact strength (with a notch) | | BB | AA | BB | BB | BB |
| | Flame retardancy | | AA | AA | AA | AA | AA |
| | Continuous formability | Change in gate | AA | AA | AA | AA | AA |
| | (5000 shots continuous | cross-sectional | | | | | |
| | formability evaluation) | area | | | | | |

| | | | | | |
|---|---|---|---|---|---|
| Burr in air | BB | BB | AA | BB | BB |
| vent portion | | | | | |

| | | | | | |
|---|---|---|---|---|---|
| Appearance of molded product (bleed-out) | AA | AA | AA | AA | AA |

| | Abbreviation of | | | | Example | Example | Example | Example |
|---|---|---|---|---|---|---|---|---|
| | component | | Name of compound | Product name | 6 | 7 | 8 | 9 |
| Component | Resin [mass %] | | Polypropylene resin | PP in (J715M + | 69.0 | 70.0 | 65.0 | 34.0 |
| of | | | | LR-24A) | | | | |
| Resin | | | Polyethylene resin | HJ560 | | | | |
| composition | (A) | (A1) | Aluminum hydroxide | KH-101 | | 10.0 | 10.0 | 45.0 |
| | | [mass %] | Magnesium hydroxide | N-6 | 10.0 | | | |
| | | (A2) | Phosphate ester | PX-200 | 10.0 | 10.0 | 10.0 | 10.0 |
| | | [mass %] | compound | | | | | |
| | | | Ammonium | TAIEN K | | | | |
| | | | polyphosphate | | | | | |
| | | | Calcium phosphonate | — | | | | |
| | | Total content of (A) [(A1) + (A2)] [mass %] | | | 20.0 | 20.0 | 20.0 | 55.0 |
| | | (A1):(A2) [mass ratio] | | | 50:50 | 50:50 | 50:50 | 82:18 |
| | | Phosphorous content [mass %] | | | 0.9 | 0.9 | 0.9 | 0.9 |
| | (B) [mass %] | | NOR-type HALS | NOR116FF | 1.00 | 0.05 | 5.00 | 1.00 |
| | HALS other | | NH-type HALS | Tinuvin 770DF | | | | |
| | than (B) | | NR-type HALS | Tinuvin 765 | | | | |
| | [mass %] | | | | | | | |
| | (C) | (C) | Glass fiber | ECS03T-430 | | | | |
| | | [mass %] | Long glass fiber | Content of Long | | 10.0 | 10.0 | 10.0 |
| | | | | glass fiber in | | | | |
| | | | | LR-24A | | | | |
| | | | Halloysite | APA:M | | | | |
| | | | Wollastonite | WFC10 | | | | |
| | | | Potassium titanate | TISMO D | | | | |
| | | | Carbon fiber | HTC413 | 10.0 | | | |

| | | | | |
|---|---|---|---|---|
| Average aspect ratio in Resin composition | 28 | 60 | 60 | 40 |

| Production method of Resin composition | | | Division | Division | Division | Division |
|---|---|---|---|---|---|---|
| Evaluation | Bending strength | | CC | BB | CC | BB |
| result | Impact strength (with a notch) | | BB | AA | AA | BB |
| | Flame retardancy | | AA | AA | AA | AA |
| | Continuous formability | Change in gate | AA | BB | AA | AA |
| | (5000 shots continuous | cross-sectional | | | | |
| | formability evaluation) | area | | | | |

| | | | | |
|---|---|---|---|---|
| Burr in air | BB | BB | BB | BB |
| vent portion | | | | |

| | | | | |
|---|---|---|---|---|
| Appearance of molded product (bleed-out) | AA | AA | AA | AA |

| | Abbreviation of | | | | Example | Example | Example | Example |
|---|---|---|---|---|---|---|---|---|
| | component | | Name of compound | Product name | 10 | 11 | 12 | 13 |
| Component | Resin [mass %] | | Polypropylene resin | PP in (J715M + | 61.9 | 69.0 | 74.0 | 69.0 |
| of | | | | LR-24A) | | | | |
| Resin | | | Polyethylene resin | HJ560 | | | | |
| composition | (A) | (A1) | Aluminum hydroxide | KH-101 | 10.0 | 25.0 | 0.0 | 15.0 |
| | | [mass %] | Magnesium hydroxide | N-6 | | | | |
| | | (A2) | Phosphate ester | PX-200 | | | 15.0 | 5.0 |
| | | [mass %] | compound | | | | | |
| | | | Ammonium | TAIEN K | | | | |
| | | | polyphosphate | | | | | |
| | | | Calcium phosphonate | — | 17.1 | | | |

| | Total content of (A) [(A1) + (A2)] [mass %] | | | 27.1 | 25.0 | 15.0 | 20.0 |
|---|---|---|---|---|---|---|---|
| | (A1):(A2) [mass ratio] | | | 37:63 | 100:0 | 0:100 | 75:25 |
| | Phosphorous content [mass %] | | | 4.4 | 0.0 | 1.4 | 0.45 |
| (B) [mass %] | | NOR-type HALS | NOR116FF | 1.00 | 1.00 | 1.00 | 1.00 |
| HALS other | | NH-type HALS | Tinuvin 770DF | | | | |
| than (B) | | NR-type HALS | Tinuvin 765 | | | | |
| [mass %] | | | | | | | |
| (C) | (C) | Glass fiber | ECS03T-430 | | | | |
| | [mass %] | Long glass fiber | Content of Long | 10.0 | 5.0 | 10.0 | 10.0 |
| | | | glass fiber in | | | | |
| | | | LR-24A | | | | |
| | | Halloysite | APA:M | | | | |
| | | Wollastonite | WFC10 | | | | |
| | | Potassium titanate | TISMO D | | | | |
| | | Carbon fiber | HTC413 | | | | |

| | | | | |
|---|---|---|---|---|
| Average aspect ratio in Resin composition | 50 | 60 | 60 | 60 |

| Production method of Resin composition | | Division | Division | Division | Division |
|---|---|---|---|---|---|
| Evaluation | Bending strength | BB | BB | BB | BB |
| result | Impact strength (with a notch) | AA | AA | AA | AA |
| | Flame retardancy | AA | AA | AA | AA |

| | | | | | |
|---|---|---|---|---|---|
| Continuous formability | Change in gate | AA | AA | AA | AA |
| (5000 shots continuous | cross-sectional | | | | |
| formability evaluation) | area | | | | |

| | | | | |
|---|---|---|---|---|
| Burr in air | CC | AA | CC | AA |
| vent portion | | | | |

| | | | | |
|---|---|---|---|---|
| Appearance of molded product (bleed-out) | AA | AA | AA | AA |

TABLE II

| | Abbreviation of | | | | Example | Example | Example | Example | Example |
|---|---|---|---|---|---|---|---|---|---|
| | component | | Name of compound | Product name | 14 | 15 | 16 | 17 | 18 |
| Component | Resin [mass %] | | Polypropylene resin | PP in (J715M + | 61.0 | 77.5 | 74.0 | 64.0 | 15.7 |
| of | | | | LR-24A) | | | | | |
| Resin | | | Polyethylene resin | HJ560 | | | | | 52.0 |
| composition | (A) | (A1) | Aluminum hydroxide | KH-101 | 10.0 | 10.0 | | | 10.0 |
| | | [mass %] | Magnesium hydroxide | N-6 | | | 10.0 | 10.0 | |
| | | (A2) | Phosphate ester | PX-200 | 10.0 | 10.0 | 10.0 | | 10.0 |
| | | [mass %] | compound | | | | | | |
| | | | Ammonium | TAIEN K | | | | 20.0 | |
| | | | polyphosphate | | | | | | |
| | | | Calcium phosphonate | — | | | | | |
| | | Total content of (A) [(A1) + (A2)] [mass %] | | | 20.0 | 20.0 | 20.0 | 30.0 | 20.0 |
| | | (A1):(A2) [mass ratio] | | | 50:50 | 50:50 | 50:50 | 33.3:66.7 | 50:50 |
| | | Phosphorous content [mass %] | | | 0.9 | 0.9 | 0.9 | 3.0 | 0.9 |
| | (B) [mass %] | | NOR-type HALS | NOR116FF | 1.00 | 1.00 | 1.00 | 1.00 | 1.00 |
| | HALS other | | NH-type HALS | Tinuvin 770DF | | | | | |
| | then (B) | | NR-type HALS | Tinuvin 765 | | | | | |
| | [mass %] | | | | | | | | |
| | (C) | (C) | Glass fiber | ECS03T-430 | | | | | |
| | | [mass %] | Long glass fiber | Content of Long | 18.0 | 1.5 | 5.0 | 5.0 | 10.0 |
| | | | | glass fiber in | | | | | |
| | | | | LR-24A | | | | | |
| | | | Halloysite | APA:M | | | | | |
| | | | Wollastonite | WFC10 | | | | | |
| | | | Potassium titanate | TISMO D | | | | | |
| | | | Carbon fiber | HTC413 | | | | | |

| | | | | | |
|---|---|---|---|---|---|
| Average aspect ratio in Resin composition | 60 | 80 | 40 | 40 | 60 |

| Production method of Resin composition | | | Division | Division | Division | Division | Division |
|---|---|---|---|---|---|---|---|
| Evaluation | Bending strength | | AA | CC | BB | BB | BB |
| result | Impact strength (with a notch) | | AA | AA | BB | BB | AA |
| | Flame retardancy | | AA | AA | AA | AA | AA |
| | Continuous formability | Change in gate | BB | AA | AA | AA | AA |
| | (5000 shots continuous | cross-sectional | | | | | |
| | formability evaluation) | area | | | | | |

| | | | | | |
|---|---|---|---|---|---|
| Burr in air | BB | BB | BB | BB | BB |
| vent portion | | | | | |

| | | | | | |
|---|---|---|---|---|---|
| Appearance of molded product (bleed-out) | AA | AA | AA | AA | AA |

| | Abbreviation of | | | | Comparative | Comparative | Comparative | Comparative |
|---|---|---|---|---|---|---|---|---|
| | component | | Name of compound | Product name | Example 1 | Example 2 | Example 3 | Example 4 |
| Component | Resin [mass %] | | Polypropylene resin | PP in (J715M + | 69.0 | 69.0 | 69.0 | 81.0 |
| of | | | | LR-24A) | | | | |
| Resin | | | Polyethylene resin | HJ560 | | | | |
| composition | (A) | (A1) | Aluminum hydroxide | KH-101 | 10.0 | 10.0 | 10.0 | 6.0 |
| | | [mass %] | Magnesium hydroxide | N-6 | | | | |
| | | (A2) | Phosphate ester | PX-200 | 10.0 | 10.0 | 10.0 | 2.0 |
| | | [mass %] | compound | | | | | |
| | | | Ammonium | TAIEN K | | | | |
| | | | polyphosphate | | | | | |
| | | | Calcium phosphonate | — | | | | |
| | | Total content of (A) [(A1) + (A2)] [mass %] | | | 20.0 | 20.0 | 20.0 | 8.0 |
| | | (A1):(A2) [mass ratio] | | | 50:50 | 50:50 | 50:50 | 75:25 |
| | | Phosphorous content [mass %] | | | 0.9 | 0.9 | 0.9 | 0.1 |
| | (B) [mass %] | | NOR-type HALS | NOR116FF | 1.00 | | | 1.00 |
| | HALS other | | NH-type HALS | Tinuvin 770DF | | 1.00 | | |
| | then (B) | | NR-type HALS | Tinuvin 765 | | | 1.00 | |
| | [mass %] | | | | | | | |
| | (C) | (C) | Glass fiber | ECS03T-430 | 10.0 | | | |
| | | [mass %] | Long glass fiber | Content of Long | | 10.0 | 10.0 | 10.0 |
| | | | | glass fiber in | | | | |
| | | | | LR-24A | | | | |
| | | | Halloysite | APA:M | | | | |
| | | | Wollastonite | WFC10 | | | | |
| | | | Potassium titanate | TISMO D | | | | |
| | | | Carbon fiber | HTC413 | | | | |
| | | Average aspect ratio in Resin composition | | | 8 | 60 | 60 | 70 |
| Production method of Resin composition | | | | | Batch | Division | Division | Division |
| Evaluation | Bending strength | | | | DD | BB | BB | BB |
| result | Impact strength (with a notch) | | | | BB | AA | AA | BB |
| | Flame retardancy | | | | AA | AA | AA | BB |
| | Continuous formability | | | Change in gate | AA | CC | CC | AA |
| | (5000 shots continuous | | | cross-sectional | | | | |
| | formability evaluation) | | | area | | | | |
| | | | | Burr in air | BB | BB | BB | BB |
| | | | | vent portion | | | | |
| | Appearance of molded product (bleed-out) | | | | AA | AA | AA | AA |
| | Abbreviation of | | | | Comparative | Comparative | Comparative | Comparative |
| | component | | Name of compound | Product name | Example 5 | Example 6 | Example 7 | Example 7 |
| Component | Resin [mass %] | | Polypropylene resin | PP in (J715M + | 24.0 | 57.6 | 57.0 | 78.5 |
| of | | | | LR-24A) | | | | |
| Resin | | | Polyethylene resin | HJ560 | | | | |
| composition | (A) | (A1) | Aluminum hydroxide | KH-101 | 55.0 | 10.0 | 10.0 | 10.0 |
| | | [mass %] | Magnesium hydroxide | N-6 | | | | |
| | | (A2) | Phosphate ester | PX-200 | 10.0 | | 10.0 | 10.0 |
| | | [mass %] | compound | | | | | |
| | | | Ammonium | TAIEN K | | | | |
| | | | polyphosphate | | | | | |
| | | | Calcium phosphonate | — | | 21.4 | | |
| | | Total content of (A) [(A1) + (A2)] [mass %] | | | 65.0 | 31.4 | 20.0 | 20.0 |
| | | (A1):(A2) [mass ratio] | | | 85:15 | 32:68 | 50:50 | 50:50 |
| | | Phosphorous content [mass %] | | | 0.9 | 5.5 | 0.9 | 0.9 |
| | (B) [mass %] | | NOR-type HALS | NOR116FF | 1.00 | 1.00 | 1.00 | 1.00 |
| | HALS other | | NH-type HALS | Tinuvin 770DF | | | | |
| | then (B) | | NR-type HALS | Tinuvin 765 | | | | |
| | [mass %] | | | | | | | |
| | (C) | (C) | Glass fiber | ECS03T-430 | | | | |
| | | [mass %] | Long glass fiber | Content of Long | 10.0 | 10.0 | 22.0 | 0.5 |
| | | | | glass fiber in | | | | |
| | | | | LR-24A | | | | |
| | | | Halloysite | APA:M | | | | |
| | | | Wollastonite | WFC10 | | | | |
| | | | Potassium titanate | TISMO D | | | | |
| | | | Carbon fiber | HTC413 | | | | |

| | | | | |
|---|---|---|---|---|
| Average aspect ratio in Resin composition | 30 | 50 | 60 | 80 |

| Production method of Resin composition | | | Division | Division | Division | Division |
|---|---|---|---|---|---|---|
| Evaluation | Bending strength | | BB | BB | AA | DD |
| result | Impact strength (with a notch) | | DD | BB | BB | BB |
| | Flame retardancy | | AA | AA | AA | AA |
| | Continuous formability | Change in gate | AA | AA | CC | AA |
| | (5000 shots continuous | cross-sectional | | | | |
| | formability evaluation) | area | | | | |

| | | | | |
|---|---|---|---|---|
| Burr in air | BB | CC | BB | BB |
| vent portion | | | | |

| | | | | |
|---|---|---|---|---|
| Appearance of molded product (bleed-out) | AA | BB | AA | AA |

From Table I and Table II, it can be seen that the resin compositions of the present invention may be used to economically produce an injection molded product with excellent mechanical strength, flame retardancy and appearance with stable quality.

Although embodiments of the present invention have been described in detail, the disclosed embodiments are made for purposes of illustration and example only and not limitation. The scope of the present invention should be interpreted by terms of the appended claims.

What is claimed is:

1. A resin composition for injection molding comprising a polyolefin resin, containing:
at least one selected from the group consisting of aluminum hydroxide, magnesium hydroxide and a phosphorus compound in an amount of 10 to 60 mass %;
a NOR-type hindered amine compound in an amount of 0.05 to 5 mass %; and
a fibrous filler having an aspect ratio of 10 or more in an amount of 1 to 20 mass %, respectively, relative to the total amount of the resin composition,
wherein a phosphorous content is 5 mass % or less relative to the total amount of the resin composition.

2. The resin composition of claim 1, wherein the polyolefin resin is a polypropylene resin.

3. The resin composition according to claim 1, wherein the phosphorus compound includes a phosphate ester compound.

4. The resin composition according to claim 1, wherein a mass ratio of a total content of aluminum hydroxide and magnesium hydroxide to a content of the phosphorus compound is in the range of 100:0 to 75:25.

5. The resin composition according to claim 1, wherein the aspect ratio of the fibrous filler is 50 or more.

6. The resin composition according to claim 1, wherein the fibrous filler contains halloysite.

7. A method for producing a resin composition according to claim 1, comprising:
a first step of melt kneading the polyolefin resin, at least one selected from the group consisting of aluminum hydroxide, magnesium hydroxide and a phosphorus compound, and the NOR-type hindered amine compound to obtain a resin mixture; and
a second step of melt kneading the resin mixture with a raw material component of the fibrous filler having an aspect ratio of 10 or more.
